(19) United States
(12) Patent Application Publication
(10) Pub. No.: US 2007/0299578 A1
(43) Pub. Date: Dec. 27, 2007

(54) Tire Information Detecting Device

(75) Inventors: Manabu Kato, Aichi-ken (JP); Eiji Fujioka, Aichi-ken (JP)

Correspondence Address: SUGHRUE MION, PLLC, 2100 PENNSYLVANIA AVENUE, N.W., SUITE 800, WASHINGTON, DC, 20037, US

(73) Assignee: AISIN SEIKI KABUSHIKI KAISHA, Kariya-shi, Aichi-ken (JP)

(21) Appl. No.: 11/662,383

(22) PCT Filed: Aug. 19, 2005
(86) PCT No.: PCT/JP05/15149

§ 371 Date: Mar. 9, 2007

(30) Foreign Application Priority Data
Sep. 24, 2004 (JP) 2004-278022

(51) Int. Cl. G06F 19/00

(52) U.S. Cl. 701/33

(57) ABSTRACT

A tire information detection device including a housing fixed to a support member made of a conductive material and arranged on a vehicle is provided. A wheel velocity sensor for detecting the rotation velocity of a wheel and a receiver for wirelessly receiving air pressure information of a tire are arranged in the housing. A controller performs control in accordance with the detected rotation velocity and the air pressure information received by the receiver. The receiver includes a wireless frequency input terminal electrically connected to the support member. Therefore, the tire information detection device includes the receiver that stably receives information such as air pressure of the tire with a low cost while also being capable of processing vehicle velocity information.

### TECHNICAL FIELD

The present invention relates to a tire information detection device, and more particularly, to a tire information detection device for stably receiving a wireless signal output from a transmitter arranged in the tire.

### BACKGROUND ART

Patent document 1 (refer to FIGS. 2 and 3 of the document) describes a prior art tire information detection device including a receiver for receiving a wireless signal output from a transmitter arranged in a tire. In this device, the transmitter (7) is arranged on the rim of a tire wheel. The receiver (5) is attached to stays (41, 42), each of which has one end fixed to a hub (1). The other end of each stay (41, 42) is in a free state. Thus, the receiver (5) is fixed to the stays (41, 42) in a cantilevered state.

However, if such a receiver is fixed in a cantilevered state, the attached state of the receiver is unstable. Thus, the reception signal may not be stable.

Further, a reception antenna is required for the receiver to receive signals. Such a reception antenna must be separately prepared. This increases costs.
Patent Document 1: Japanese Laid-Open Patent Publication No. 9-240228

### DISCLOSURE OF THE INVENTION

### Problems that are to be Solved by the Invention

It is an object of the present invention to provide a tire information detection device including a receiver that stably receives information such as air pressure of the tire with a low cost while also being capable of processing vehicle velocity information.

### Means for Solving the Problems

In order to achieve the above object, the present invention provides a tire information detection device including a housing fixed to a support member made of a conductive material and arranged on a vehicle. A wheel velocity sensor for detecting the rotation velocity of a wheel and a receiver for wirelessly receiving air pressure information of a tire are arranged in the housing. A controller performs control in accordance with the detected rotation velocity and the air pressure information received by the receiver. The receiver includes a wireless frequency input terminal electrically connected to the support member.

In another aspect of the present invention, the tire information detection device includes a housing fixed to a support member made of a conductive material and arranged on a vehicle; a wheel velocity sensor, arranged in the housing, for detecting the rotation velocity of a wheel; a receiver, arranged in the housing, for receiving a wireless signal containing at least the air pressure information of a tire; and a controller for performing calculation on the tire information in accordance with a received signal. The receiver includes a signal processor for performing signal-processing in accordance with a received signal. The receiver includes one of a positive power supply terminal, a reference potential terminal, and a ground terminal connected to the support member via a wire having a length of one tenth or less the wavelength of the received signal.

An antenna for receiving the air pressure information is connected to the receiver, and the antenna may be arranged in the housing.

Further, an antenna, connected to the receiver, for receiving the air pressure information may be arranged along a wiring that connects the wheel velocity sensor to the controller.

A signal output wire extending from the wheel velocity sensor may also be used as a positive power supply wire or a negative power supply wire.

### BRIEF DESCRIPTION OF THE DRAWINGS

FIG. 1 is a partial cross-sectional view showing a structure of a tire information detection device according to a first embodiment of the present invention;

FIG. 2 is an enlarged cross-sectional view of FIG. 1;

FIG. 3 is a cross-sectional view showing the structure of a second embodiment of the present invention;

FIG. 4 is a cross-sectional view showing the structure of a third embodiment of the present invention;

FIG. 5 is a cross-sectional view showing the structure of a fourth embodiment of the present invention;

FIG. 6 is a cross-sectional view showing the structure of a fifth embodiment of the present invention;

FIG. 7 is a cross-sectional view showing the structure of a sixth embodiment of the present invention;

FIG. 8 is a cross-sectional view showing the structure of a seventh embodiment of the present invention;

FIG. 9 is a cross-sectional view showing the structure of an eighth embodiment;

FIG. 10 is a cross-sectional view showing the structure of a ninth embodiment;

FIG. 11 is a cross-sectional view showing the structure of a tenth embodiment;

FIG. 12 is a cross-sectional view showing the structure of an eleventh embodiment;

FIG. 13 is a cross-sectional view showing the structure of a twelfth embodiment;

FIG. 14 is a cross-sectional view showing the structure of a thirteenth embodiment;

FIG. 15 is a cross-sectional view showing the structure of a fourteenth embodiment; and

FIG. 16 is a cross-sectional view showing the structure of a fifteenth embodiment.

### BEST MODE FOR CARRYING OUT THE INVENTION

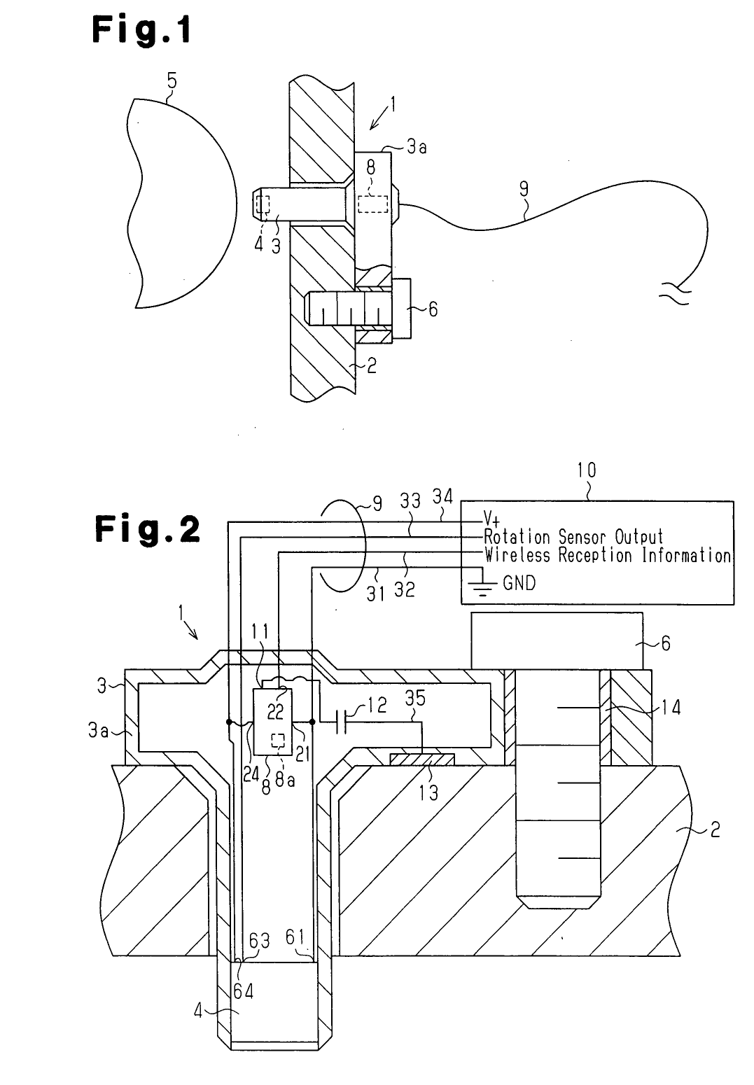

A first embodiment of the present invention will now be described with reference to the drawings. FIG. 1 is a partial cross-sectional view showing a tire information detection device 1 of the present embodiment in a state attached to a vehicle. The tire information detection device 1 includes a transmitter (not shown) incorporated in the tire (not shown), and a receiver unit 3 fixed to the vehicle body. The receiver unit 3 is fixed to a metal (conductive) support member 2 arranged on the vehicle body. The support member 2 is preferably a member that forms a suspension and the like, specifically, a knuckle arm. A wheel velocity sensor 4 is incorporated in the receiver unit 3. An inner hub (not shown) supported by the suspension rotatably holds a disc wheel of the brake. A rotor 5 that rotates integrally with the disc wheel is arranged in the inner hub. The wheel velocity sensor 4 detects the rotation velocity of the disc wheel, that is, the wheel rotation velocity by detecting changes in the magnetic field generated by the rotor 5.

Specifically, a sensor of the type that detects cyclic changes in the magnetic flux density is used as the wheel velocity sensor 4 in the present embodiment. In other words, the magnetic flux density passing through the wheel velocity sensor 4 changes cyclically in accordance with the rotation of the rotor 5, and such cyclic change is detected by the wheel velocity sensor 4. In FIG. 1, the receiver unit 3 is fixed to the support member 2 by a bolt 6 serving as a fastening member. However, the fastening is not limited in such a manner, and a snap-in fastening method may be employed.

As shown in FIG. 2, a receiver 8 is arranged in a housing 3a of the receiver unit 3. The receiver 8 is connected to a controller 10 by a harness 9 extending out of the housing 3a. The harness 9 includes a negative power supply wire (GND line) 31, signal output wires 32 and 33, and a positive power supply wire 34 bundled together. The receiver 8 is connected to the controller 10 by the negative power supply wire 31, the signal output wire 32 and the positive power supply wire 34. The receiver 8 includes a ground terminal 21 connected to the negative power supply wire 31, an output terminal 22 connected to the signal output wire 32, and a positive power supply terminal 24 connected to the power supply wire 34. The wheel velocity sensor 4 is connected to the controller 10 by the negative power supply wire 31, the signal output wire 33, and the positive power supply wire 34. The wheel velocity sensor 4 includes a ground terminal 61 connected to the negative power supply wire 31, an output terminal 63 connected to the signal output wire 33, and a positive power supply terminal 64 connected to the power supply wire 34. The controller 10 supplies power to the wheel velocity sensor 4 and the receiver 8 through the negative power supply wire 31 and the positive power supply wire 34. The receiver 8 transmits a received signal to the controller 10 via the signal output wire 32. The wheel velocity sensor 4 transmits detected information to the controller 10 via the signal output wire 33.

An electrode 13 is arranged on the surface of the housing 3a that abuts against the support member 2. The electrode 13 is electrically connected to a radio frequency (RF) input terminal 11 of the receiver 8 by a signal line 35. Through such a connection, the support member 2 functions as the antenna for the receiver 8 in the tire information detection device 1. Thus, a separate antenna does not have to be arranged. The RF input terminal 11 of the receiver 8 is connected to the electrode 13 via a capacitor 12. The capacitor 12 tolerates the flow of alternating current and stops the flow of direct current between the receiver 8 and the electrode 13. It is preferred that the absolute value of the impedance of the capacitor 12 be one tenth or less the absolute value of the input impedance of the RF input terminal 11. The receiver 8 generates a new signal so that a signal input to the RF input terminal 11 is sent from the support member 2 to the controller 10.

The present embodiment has the advantages described below.

(1) The knuckle arm (support member 2) of the vehicle to which the receiver unit 3 is fixed is electrically connected to the RF input terminal 11 of the receiver 8. Therefore, the support member 2 functions as an antenna that receives a signal from the transmitter. This ensures that the receiver 8 receives transmitted signals without preparing a separate antenna. Thus, the receiver 8 stably receives information such as the air pressure of the tire at a low cost. Further, the receiver unit 3 inputs the vehicle velocity information from the wheel velocity sensor 4 to the controller 10 at the same time as when receiving the tire air pressure information. This enables the controller 10 to simultaneously process the tire air pressure information and the vehicle velocity information. Additionally, the receiver 8 stably receives signals from the transmitter without an exclusive reception antenna under a condition in which the positional relationship between the transmitter and the receiver 8 changes as the tire rotates.

(2) The RF input terminal 11 of the receiver 8 is connected to the support member 2 via the capacitor 12. If a potential difference is created between the receiver 8 and the support member 2 when the RF input terminal 11 and the support member 2 are directly connected, direct current flows between the support member 2 and the receiver 8 in accordance with such potential difference. The direct current may damage various electronic components of the receiver 8. However, the capacitor 12 is arranged between the support member 2 and the RF input terminal 11 in the present embodiment. Thus, the flow of such direct current is cut by the capacitor 12. Accordingly, the receiver 8 is protected from unnecessary current.

(3) The housing 3a of the receiver unit 3 is fixed to the support member 2 by the bolt 6 (fastening member). This stably fixes the receiver unit 3. Further, the receiver 8 is arranged in the housing 3a of the fixed receiver unit 3. This stabilizes the attachment state of the receiver 8 and enables the receiver 8 to stably receive the signal from the transmitter.

(4) The receiver 8 includes a signal processor 8a for generating a new signal in accordance with the received signal. Specifically, the signal processor 8a generates a new signal by lowering the frequency of the carrier with a mixer or the like. By amplifying the output of the mixer, the signal processor 8a can avoid the S/N (Signal/Noise) ratio of the signal transmitted to the controller 10 from being adversely lowered. The S/N ratio is thus ensured without the use of a coaxial cable. The signal processor 8a also ensures a further effective S/N ratio by performing signal-processing further including a wave detection circuit. The tire information of each wheel of the vehicle is sent to the receiver 8 in the tire information detection device 1. Thus, if each receiver 8 were to receive the tire information of the corresponding wheel, at least four receivers 8 would be required for a single vehicle. However, in the present embodiment, the tire information for four wheels is signal-processed with only one demodulation circuit in the receiver 8 by changing the carrier frequency and passing through the low pass filter.

(5) The receiver 8 and the wheel velocity sensor 4 share the positive power supply wire 34. Thus, only one positive power supply wire 34 is used. The reduction in the number of wires lowers costs.

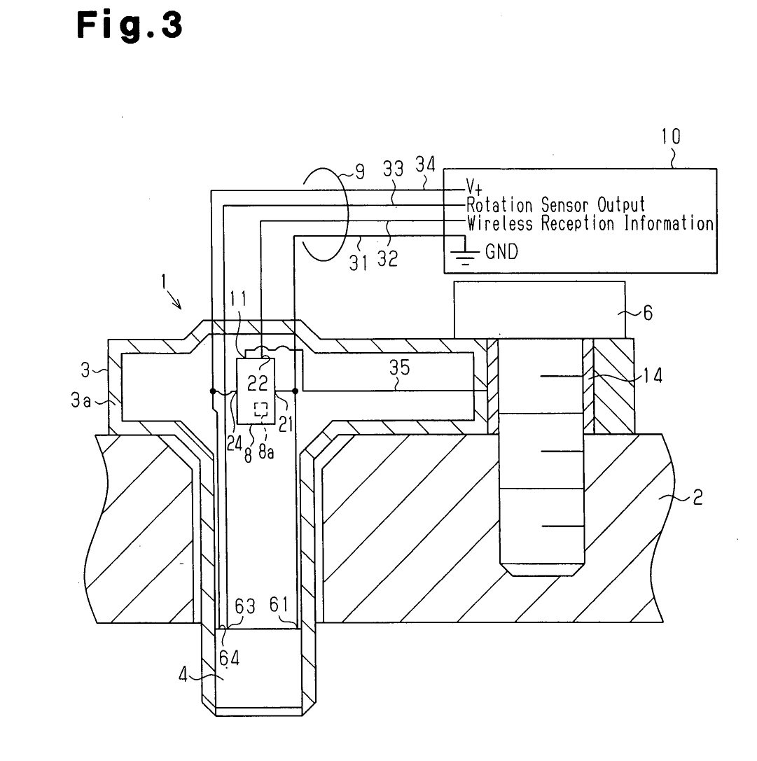

FIG. 3 is a diagram showing a second embodiment of the present invention. In FIG. 2, the RF input terminal 11 of the receiver 8 is connected to the electrode 13 arranged on the surface of the housing 3a that abuts against the support member 2. However, in the second embodiment, the RF input terminal 11 of the receiver 8 is connected to a metal bushing 14 arranged between the housing 3a and the bolt 6. That is, the signal line 35 connects the receiver 8 to the metal bushing 14. Since the metal bushing 14 is in contact with the support member 2, the RF input terminal 11 is ultimately connected to the support member 2 via the metal bushing 14. The capacitor 12 is omitted in FIG. 3.

Although not shown, the receiver 8 may include a matching circuit, a band pass filter, an amplifier and a demodulation circuit. It is preferred that the signal input to the receiver 8 from the RF input terminal 11 be signal-processed in the receiver 8 by the matching circuit, the band pass filter, the amplifier and the like, and then input to the demodulation circuit.

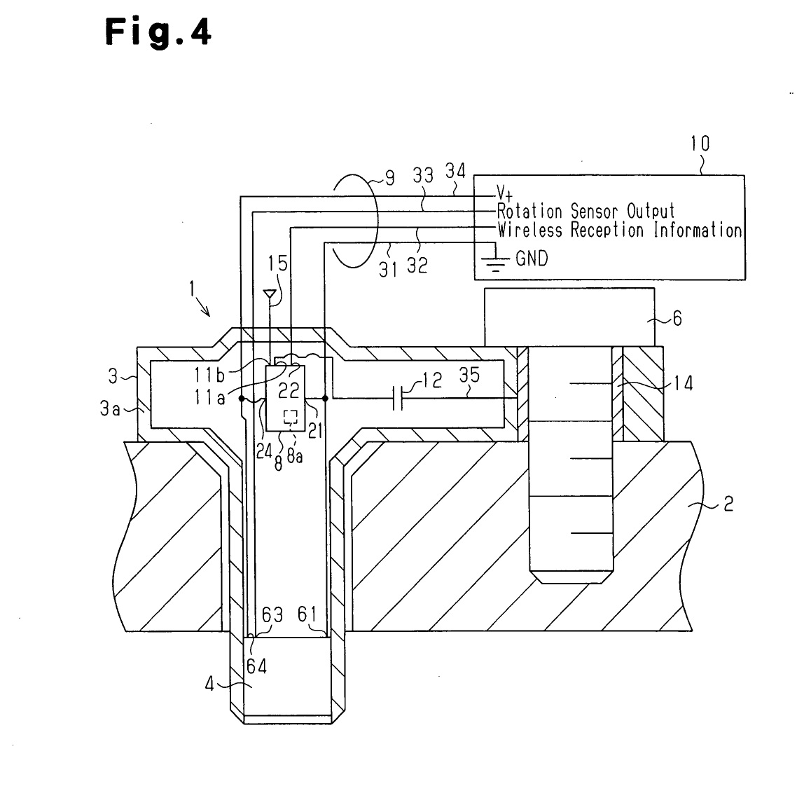

FIG. 4 shows a third embodiment of the present invention. The fastening method of the tire information detection device 1 and the configuration of the receiver unit 3 are the same as that shown in FIG. 3. However, the third embodiment differs from the above embodiments in that the RF input terminal 11 of the receiver 8 has two or more systems, which are formed by a first input terminal 11a and a second input terminal 11b. Among the first and second input terminals 11a and 11b, the first input terminal 11a is conductive so as to allow the flow of alternating current to the support member 2 through the capacitor 12 and the metal bushing 14. The second input terminal 11b is connected to one or more external antennas 15 or is connected to one or more built-in antennas. The receiver 8 is connected to a plurality of antennas (support member 2 and antenna 15) to form a diversity system. Such a combination further ensures the reception of signals. Although not shown, the receiver 8 may include a matching circuit, a band pass filter, an amplifier and a demodulation circuit. It is preferred that the signal input to the receiver 8 from the RF input terminal 11 is signal-processed in the receiver 8 by the matching circuit, the band pass filter, the amplifier and the like, and then input to the demodulation circuit.

The present embodiment has the following advantage.

(6) The RF input terminal (second input terminal 11b) is arranged in the receiver 8 in addition to the RF input terminal (first input terminal 11a), which is connected to the support member 2, and the antenna 15 is connected to the additionally arranged second input terminal 11b. The present embodiment thus forms a diversity system. This realizes a further stable reception state in the receiver 8. Even when the positional relationship between the transmitter and the antenna 15 or between the transmitter and the support member 2 changes due to the rotation of the tire or when the strength of the received radio wave of the antenna 15 and the support member 2 changes, a stable reception state is constantly obtained by selecting the stronger reception signal.

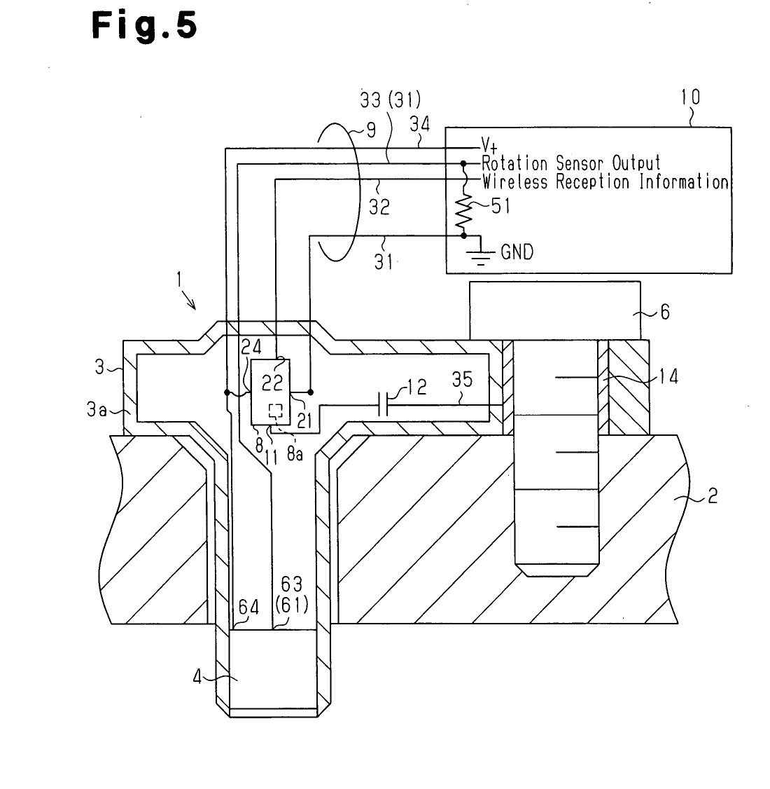

In a fourth embodiment of the present invention, as shown in FIG. 5, the tire information detection device 1 may also be applied to a so-called two-wire type in which the wheel velocity sensor 4 and the controller 10 are connected by two wires. In FIG. 5, the wheel velocity sensor 4 includes a detection element for outputting a signal corresponding to the magnetic flux density such as MR element or Hall element, and an IC chip for processing the output signal of the detection element. Only the signal output wire 33 and the positive power supply wire 34 are connected to the wheel velocity sensor 4. The signal output wire 33 is connected to the negative power supply (GND) via a resistor 51. That is, the signal output wire 33 extending from the wheel velocity sensor 4 is also used as the negative power supply wire 31. In other words, the output signal of the wheel velocity sensor 4 is superimposed on the negative power supply wire 31. The wheel velocity sensor 4 may use a coil. In the present embodiment, the signal line 35 is connected to the metal bushing 14 to connect the receiver 8 to the support member 2 via the capacitor 12. However, the present invention is not limited in such a manner, and the electrode 13 may be arranged on the surface of the housing 3a that abuts against the support member 2, and the receiver 8 (RF input terminal 11) may be connected to the electrode 13.

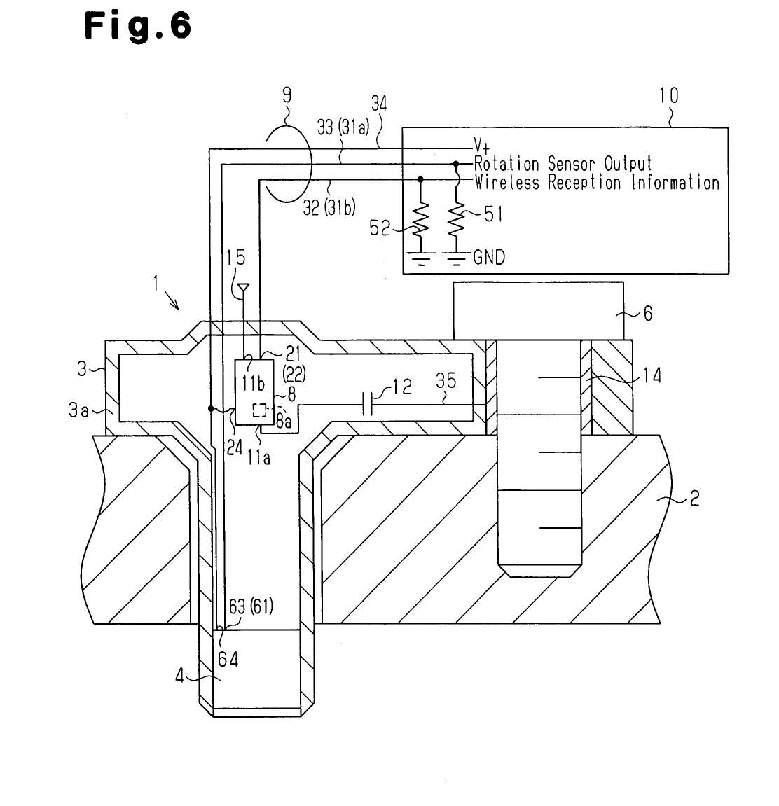

FIG. 6 shows a fifth embodiment of the present invention. The wheel velocity sensor 4 includes a detection element for outputting a signal corresponding to the magnetic flux density such as MR element or Hall element, and an IC chip for signal-processing the output of the detection element. The wheel velocity sensor 4 is a two-wire type like that in FIG. 5, and only the signal output wire 33 and the positive power supply wire 34 are connected to the wheel velocity sensor 4. The signal output wire 33 is connected to the negative power supply (GND) via a resistor 51. Thus, the signal output wire 33 also functions as a first negative power supply wire 31a. That is, the output signal of the wheel velocity sensor 4 is superimposed on the first negative power supply wire 31a. In the present embodiment, the signal output wire 32 extending from the receiver 8 is connected to the negative power supply (GND) via a resistor 52. The signal output wire 32 thus functions as a second negative power supply wire 31b. In other words, the output signal of the receiver 8 is superimposed on the second negative power supply wire 31b. The receiver 8 and the wheel velocity sensor 4 share the positive power supply wire 34. Thus, the number of wires accommodated in the harness 9 connecting the receiver unit 3 to the controller 10 is only three, the signal output wires 32 and 33 and the positive power supply wire 34. This reduces costs. Further, the wheel velocity sensor 4 may be a coil.

The present embodiment has the following further advantage.

(7) The signal output wire 32 extending from the receiver 8 is also used as the negative power supply wire (second negative power supply wire 31b). Thus, the signal output wire and the negative power supply wire that are connected to the receiver 8 is a signal output wire 32. This lowers costs since the number of wires is reduced.

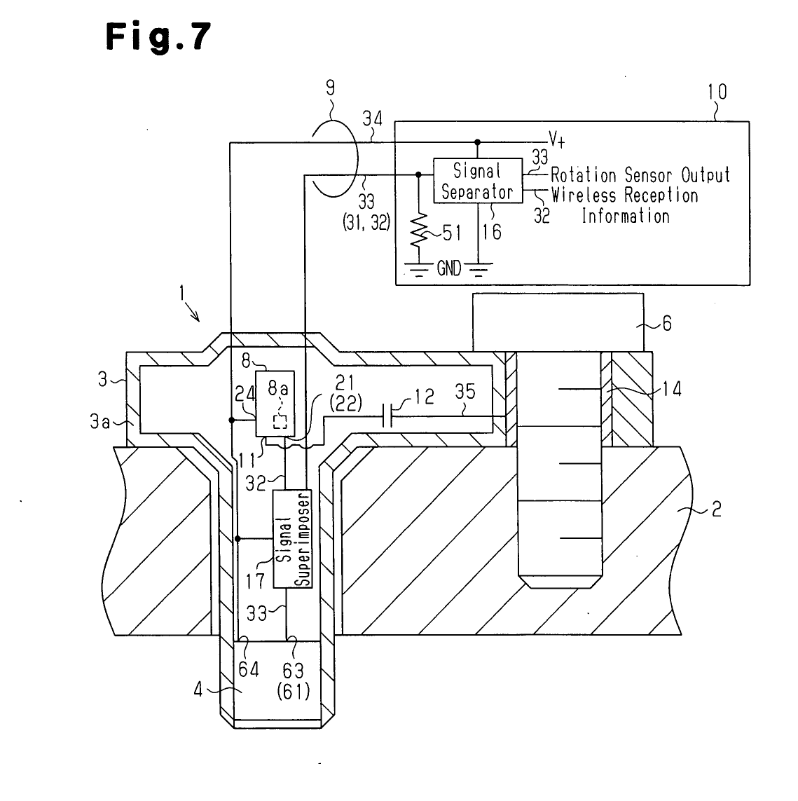

FIG. 7 shows a sixth embodiment of the present invention. In the tire information detection device 1 shown in FIG. 7, the two-wire type wheel velocity sensor 4 and the receiver 8 shown in FIG. 6 are used. The controller 10 includes a signal separator 16, and the receiver unit 3 includes a signal superimposer 17. The signal output wire 33 extending from the wheel velocity sensor 4 and the signal output wire 32 extending from the receiver 8 are connected to the signal superimposer 17. The signal output wire 33 extending from the signal superimposer 17 is connected to the signal separator 16. The wheel velocity sensor 4 outputs a pulse to the receiver 8 at a frequency proportional to the rotation velocity of the rotor 5. The receiver 8 digitizes information such as the tire air pressure and inputs a pulse train to the signal superimposer 17. The signal superimposer 17 changes the pulse shape (specifically, pulse voltage, pulse width etc.) of the pulse train in the output from the wheel velocity sensor 4 to prepare two or more types of pulse shapes. The signal superimposer 17 then superimposes the signal from the receiver 8 on the signal from the wheel velocity sensor 4 with the pulse train from the wheel velocity sensor 4 as a carrier output to the controller 10. The signal separator 16 of the controller 10, to which the superimposed signal from the signal superimposer 17 is input, separates the detected information of the wheel velocity sensor 4 from the received information of the receiver 8.

As described above, the signal output wire 33 is shared by the wheel velocity sensor 4 and the receiver 8 between the receiver unit 3 and the controller 10. More specifically, the signal output wire 33 is commonly used as the negative power supply wire 31 and the signal output wire 32. The number of wires for connecting the receiver unit 3 to the controller 10 is thus only two, the positive power supply wire 34 and the signal output wire 33. This reduces costs. The output pulse shape of the wheel velocity sensor 4 may be demodulated, and the output of the receiver 8 may be superimposed on the modulated output as described above. However, the present invention is not limited in such a manner, and the output signal of the receiver 8 may be inserted to a low level or high level of the output signal of the wheel velocity sensor 4 using the pulse shape (value of pulse voltage, pulse width etc.), which differs from the output pulse of the wheel velocity sensor 4.

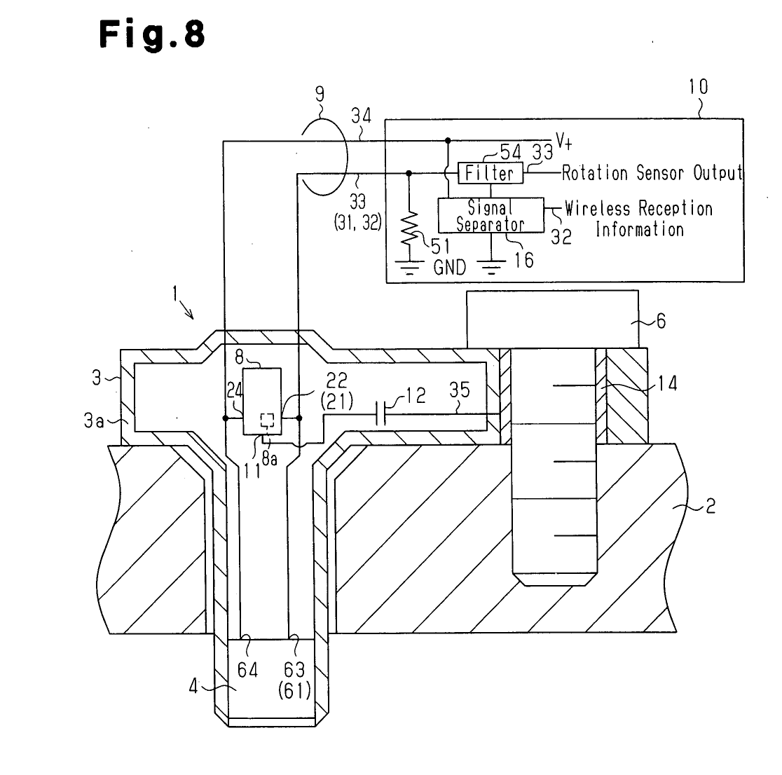

FIG. 8 shows a seventh embodiment of the present invention. The wheel velocity sensor 4 shown in FIG. 8 outputs the pulse at a frequency proportional to the rotation velocity of the rotor 5, and the receiver 8 receives and demodulates the signal containing information such as tire air pressure etc. from the transmitter. The receiver 8 modulates the carrier frequency of the signal received by the antenna (support member 2) to a frequency that is higher than the frequency band of the output from the wheel velocity sensor 4. The receiver 8 may lower and output the carrier frequency of the received signal with a mixer or a signal transmitting circuit arranged in the receiver 8 in a range that is higher than the frequency band of the output from the wheel velocity sensor 4 and adds the carrier frequency to the output of the wheel velocity sensor 4 and sends it the controller 10. The controller 10 includes a filter 54 including a low pass filter and a high pass filter. The filter 54 is connected to the common signal output wire 33 extending from the wheel velocity sensor 4 to the receiver 8. The controller 10 extracts the output from the wheel velocity sensor 4 with the low pass filter of the filter 54 and processes the output in the signal separator 16 to extract the information corresponding to the tire air pressure from the receiver 8 with the high pass filter of the filter 54. The signal output wire 33 is commonly used as the negative power supply wire 31 and the signal output wire 32. As a result, in the same manner as in FIG. 7, the wires accommodated by the harness 9 are only two, the positive power supply wire 34 and the signal output wire 33. This reduces costs. Furthermore, the output of the wheel velocity sensor 4 and the output of the receiver 8 are in frequencies of different bands. This facilitates the addition or separation of the signal from the wheel velocity sensor 4 and the signal from the receiver 8. In particular, the circuit is simpler and the cost is reduced compared to the embodiment of FIG. 7 when outputting the signal received in the receiver 8 by the antenna (support member 2) with the carrier frequency lowered by the signal transmitting circuit and the mixer in the receiver 8.

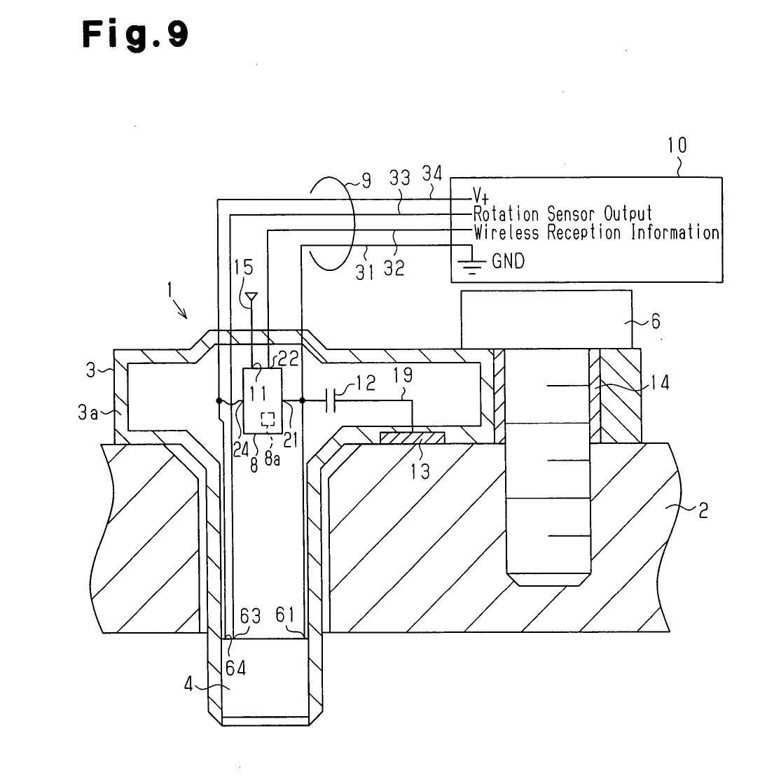

FIG. 9 shows an eighth embodiment. The receiver 8 shown in FIG. 9 is arranged in the housing 3a. The receiver 8 is connected to the controller 10 by the harness 9. The electrode 13 is arranged on the surface of the housing 3a that abuts against the support member 2. The electrode 13 is connected to the ground terminal 21 of the receiver 8 by the wire 19 via the capacitor 12. That is, the ground terminal 21 is connected so as to allow alternating current to flow to the support member 2. It is preferred that the absolute value of the impedance of the capacitor 12 be one tenth or less the absolute value of the impedance of the antenna 15 connected to the receiver 8. The length of the wire 19 for connecting the ground terminal 21 of the receiver 8 to the support member 2 is set to be one tenth of less the wavelength of the reception signal of the receiver 8.

Generally, stray capacitance is pseudo-generated between two ends of a wire as the wire becomes long. The stray capacitance generates noise and the like and it becomes difficult to obtain practical signal accuracy. In the present embodiment, the length of the wire 19 for connecting the ground terminal 21 of the receiver 8 to the support member 2 is one tenth or less the wavelength of the received signal of the receiver 8. Thus, the influence of the stray capacitance of the wire 19 on the signal received by the receiver 8 is suppressed at a low level since the length of the wire 19 is set to be sufficiently short with respect to the wavelength of the reception signal.

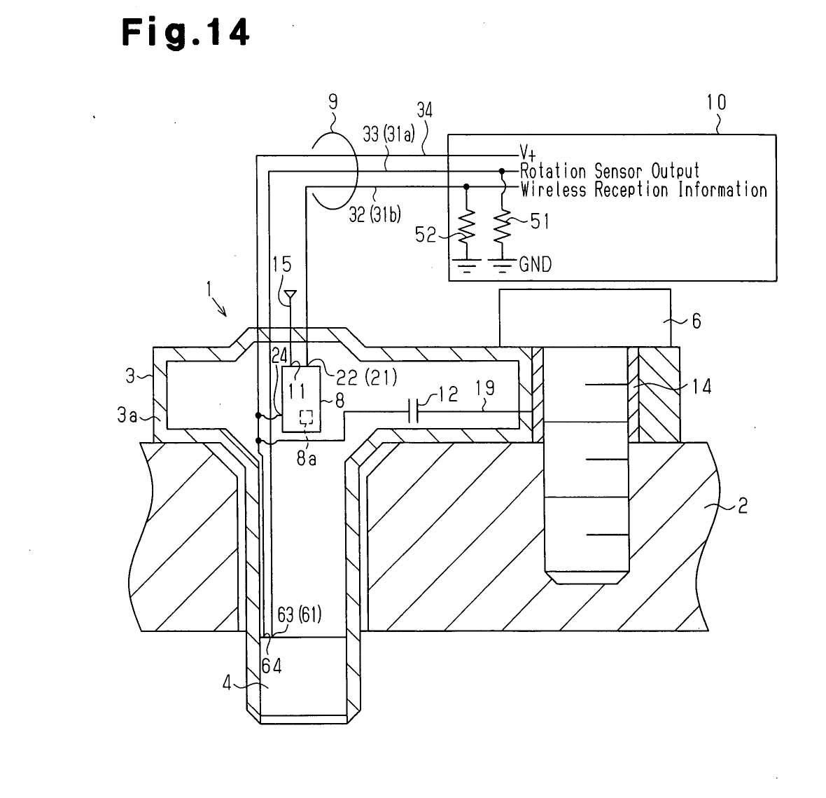

Therefore, the GND connection condition of the antenna 15 connected to the receiver 8 is stabilized, and the operation of the antenna 15 is stable. In FIG. 9, the ground terminal 21 of the receiver 8 is connected to the support member 2 by the wire 19. However, the present invention is not limited in such a manner, and the wire 19 extending from the support member 2 may be connected to a low impedance terminal having a stable potential such as the positive power supply terminal 24 (V positive terminal) of the receiver 8, as shown in FIGS. 14 to 16, which will hereinafter described. Since the metal bushing 14 is used to fix the receiver unit 3 to the support member 2 with the bolt 6, the metal bushing 14 may be used as an electrode that takes the place of the electrode 13, as shown in FIG. 11, which will be described later, and the wire 19 extending from the receiver 8 may be connected to the metal bushing 14.

The present embodiment has the following advantage.

(11) In the prior art, the support member 2 is a potentially unstable conductor for high frequency signals in the circuits of the receiver 8. Thus, the signal received by the receiver 8 is unstable and reliability is difficult to obtain. Normally, a monopole antenna such as the antenna 15 is used for the tire information detection device 1. For the receiver 8 to stably receive a signal, the potential at the ground terminal 21 of the receiver 8 must be stable for the monopole antenna 15. In other words, the size of the receiver 8 must be enlarged in the prior art to prevent the ground potential of the receiver 8 from easily changing due to low impedance. However, in the present embodiment shown in FIG. 9, the length of the wire 19 connecting the ground terminal 21 of the receiver 8 to the support member 2 is set to be one tenth or lower the wavelength of the signal received by the receiver 8. Consequently, the receiver 8 is electrically connected to the support member 2, and the receiver 8 stably receives the signal. Furthermore, the receiver unit 3 of the present embodiment includes the wheel velocity sensor 4 for detecting the rotation velocity of the wheel. Thus, the tire information detection device 1 performs control based on both the wheel velocity information related to the traveling state of the vehicle and the air pressure information of the tire.

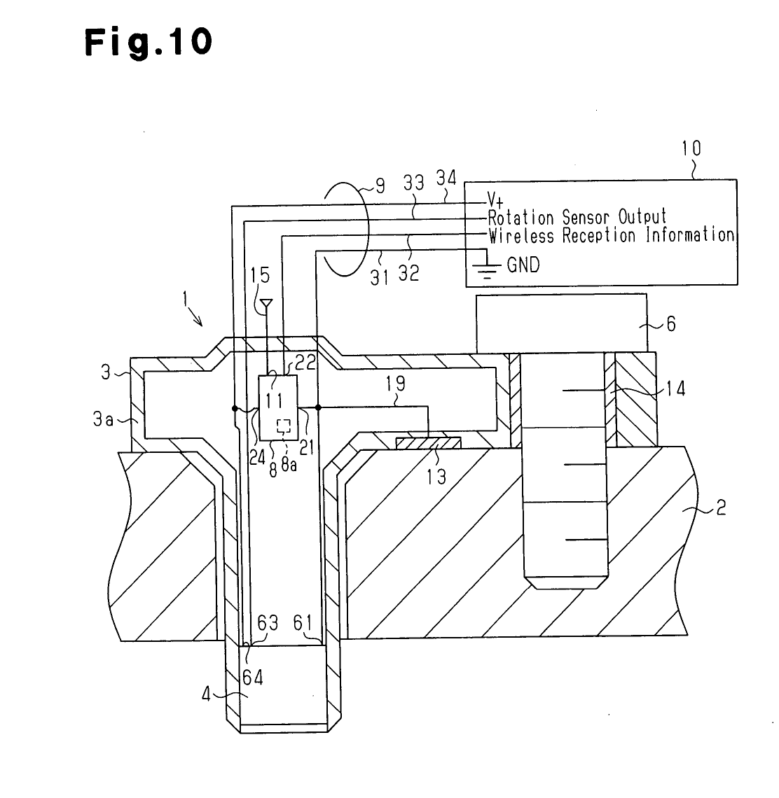

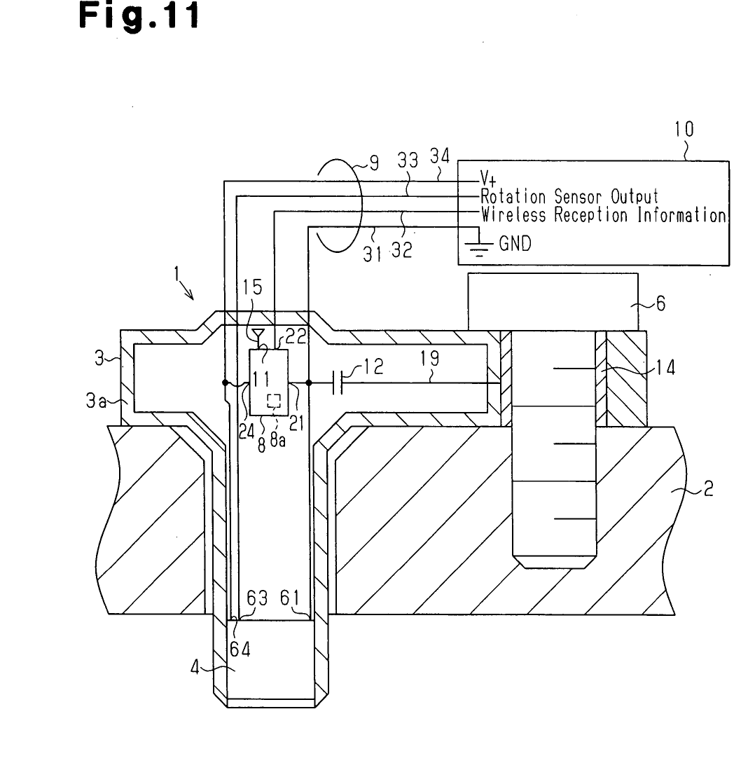

FIG. 10 shows a ninth embodiment. In FIG. 10, the attachment method of the receiver unit 3 to the support member 2 is the same as in FIG. 9. The wheel velocity sensor 4, the receiver 8 and the way each signal is input and output are the same as in FIG. 9. However, there is a difference in that the wire 19, which electrically connects the ground terminal 21 of the receiver 8 to the support member 2, is directly connected (short-circuited) to the electrode 13, which is arranged in abutment with the support member 2, without the capacitor 12 and the like arranged in between. In this case as well, the length of the wire 19 is set to be one tenth or less than the wavelength of the received signal of the receiver 8 so that the receiver 8 stably receives the signal.

FIG. 11 is a diagram showing a tenth embodiment. The antenna 15 is extended out of the housing 3a in FIG. 9, but accommodated in the housing 3a in FIG. 11. The power supplying point of the antenna 15 may be arranged in the vicinity of the support member 2, that is, in the vicinity of the GND as seen from the high frequency since the antenna 15 is arranged in the housing 3a. Therefore, further stable operation of the antenna 15 can be anticipated, and the installation of the tire information detection device 1 is facilitated since the external antenna is not necessary. To electrically connect the ground terminal 21 of the receiver 8 to the support member 2 via the capacitor 12, the wire 19 extending from the receiver 8 is connected to the metal bushing 14 that is arranged on the surface of the support member 2 fastened to the bolt 6. However, the present invention is not limited in such a manner, and the wire 19 may be connected to the electrode 13 arranged on the surface of the support member 2 in the same manner as in FIG. 9. The ground terminal 21 may be short-circuited to the support member 2 by electrically connecting the ground terminal 21 of the receiver 8 directly to the electrode 13 or the metal bushing 14 with the wire 19.

The present embodiment has the following further advantage.

(12) The antenna 15 for receiving the air pressure information of the tire is arranged in the housing 3a. Therefore, the wire of the antenna 15 is shorter and the tire information detection device 1 is miniaturized compared to when the antenna 15 is arranged as a body separate from the housing 3a or when the antenna 15 is extended out of the housing 3a.

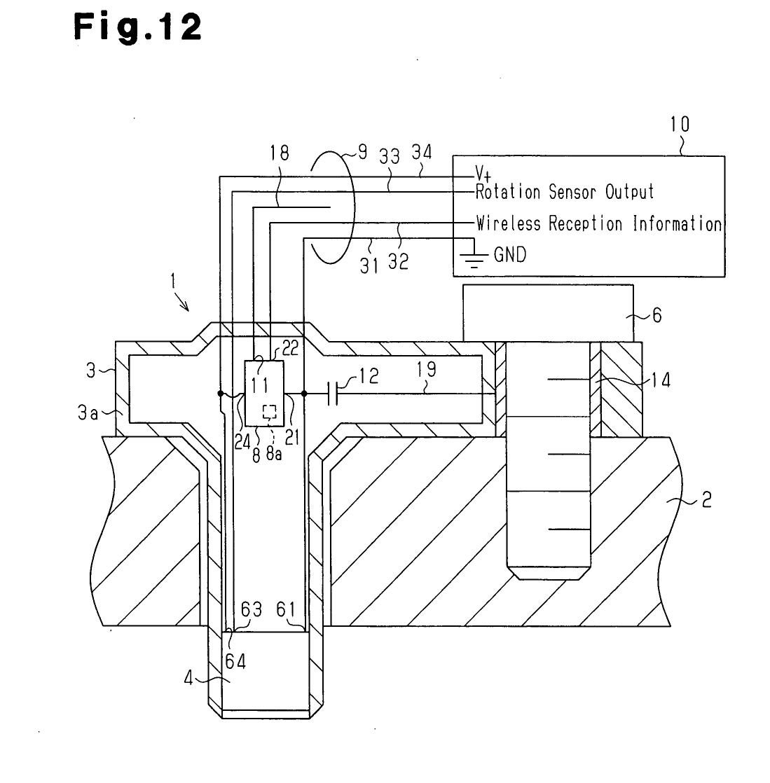

FIG. 12 is a diagram showing an eleventh embodiment. In FIG. 12, an antenna 18 is arranged along a wiring (negative power supply wire 31, signal output wires 32 and 33, and positive power supply wire 34) connecting the receiver 8 to the controller 10 in lieu of the antenna 15 shown in FIG. 9. The installation of the antenna 18 is thus facilitated since the antenna 18 may be installed together with the wires (31 to 34) connecting the receiver 8 to the controller 10. The electrical connection of the receiver 8 to the support member 2 via the capacitor 12 is similar to FIG. 9, and the wire 19 may be connected to the support member 2 via the electrode 13, the metal bushing 14 or the like.

The present embodiment has the following further advantage.

(13) The antenna 18 is arranged along the wiring (31 to 34) connecting the receiver unit 3 to the controller 10. Therefore, the antenna 18 is integrated with the wiring (31 to 34) and a separate external antenna becomes unnecessary by, for example, accommodating the antenna 18 and the wires (31 to 34) together in the harness 9.

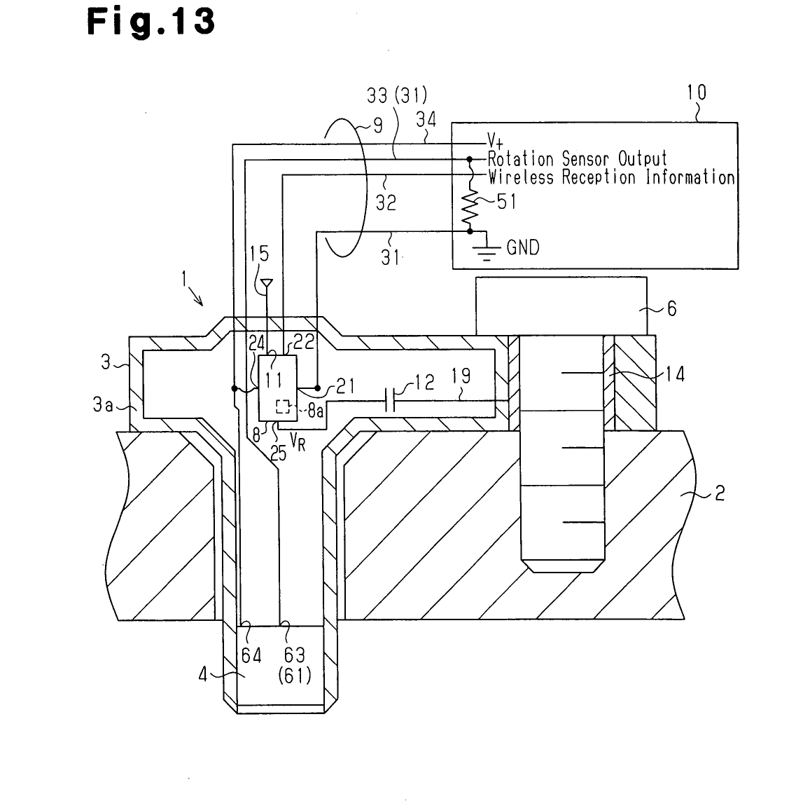

FIG. 13 is a diagram showing a twelfth embodiment. As shown in FIG. 13, the receiver 8 includes a reference potential terminal 23 corresponding to a reference potential V_{R}. The electrical connection of the receiver 8 to the support member 2 via the capacitor 12 is performed by connecting the reference potential terminal 23 of the receiver 8 to the metal bushing 14 via the wire 19. Furthermore, the wheel velocity sensor 4 may be a two-wire type. The wheel velocity sensor 4 shown in FIG. 13 includes a detection element for outputting a signal corresponding to the magnetic flux density, such as MR element and Hall element, and an IC chip for signal-processing the output of the detection element. The wheel velocity sensor 4 is a two-wire type, in which the output signal of the wheel velocity sensor 4 is superimposed on the negative power supply wire 31. Two wires, the signal output wire 33, which is also used as the negative power supply wire 31, and the positive power supply wire 34 are connected to the wheel velocity sensor 4. The wheel velocity sensor 4 may be a coil. The electrical connection of the receiver 8 to the support member 2 via the capacitor 12 may be achieved by connecting the wire 19 to the electrode 13 arranged on the surface of the support member 2 in the same manner as in FIG. 9.

The present embodiment has the following further advantage.

(14) The output signal of the wheel velocity sensor 4 is superimposed on the negative power supply wire 31. In other words, the signal output wire 33 is also used as the negative power supply wire 31. Consequently, the wires are reduced and become lighter. This reduces costs.

FIG. 14 shows a thirteenth embodiment. The wire 19 extending from the support member 2 is connected to a positive power supply terminal 24 (V positive terminal) of the receiver 8 serving as a low impedance terminal having a stable potential. The wheel velocity sensor 4 includes a detection element for outputting a signal corresponding to the magnetic flux density such as MR element or Hall element, and an IC chip for signal-processing the output signal of the detection element. The wheel velocity sensor 4 is a two-wire type, in which the output signal of the wheel velocity sensor 4 is superimposed on the first negative power supply wire 31a. The receiver 8 is a two-wire type, so that the output signal (signal output wire 32) of the receiver 8 is superimposed on the second negative power supply wire 31b. The receiver 8 and the wheel velocity sensor 4 commonly use the positive power supply wire 34. The signal output wire 33 is also used as the first negative power supply wire 31a, and the signal output wire 32 is also used as the second negative power supply wire 31b. Therefore, there are only three wires for connecting the receiver unit 3 to the controller 10 (signal output wires 32 and 33 and positive power supply wire 34). This reduces costs. The positive power supply terminal 24 of the receiver 8 is electrically connected to the metal bushing 14 via the capacitor 12.

The present invention is not limited to the structure shown in FIG. 14, and the signal output wire 33 extending from the wheel velocity sensor 4 may be used as the first positive power supply wire, and the signal output wire 32 extending from the receiver 8 may be used as the second positive power supply wire. The wheel velocity sensor 4 and the receiver 8 may share the negative power supply wire 31. The support member 2 is directly connected to the ground terminal 21 of the receiver 8 or via the capacitor 12.

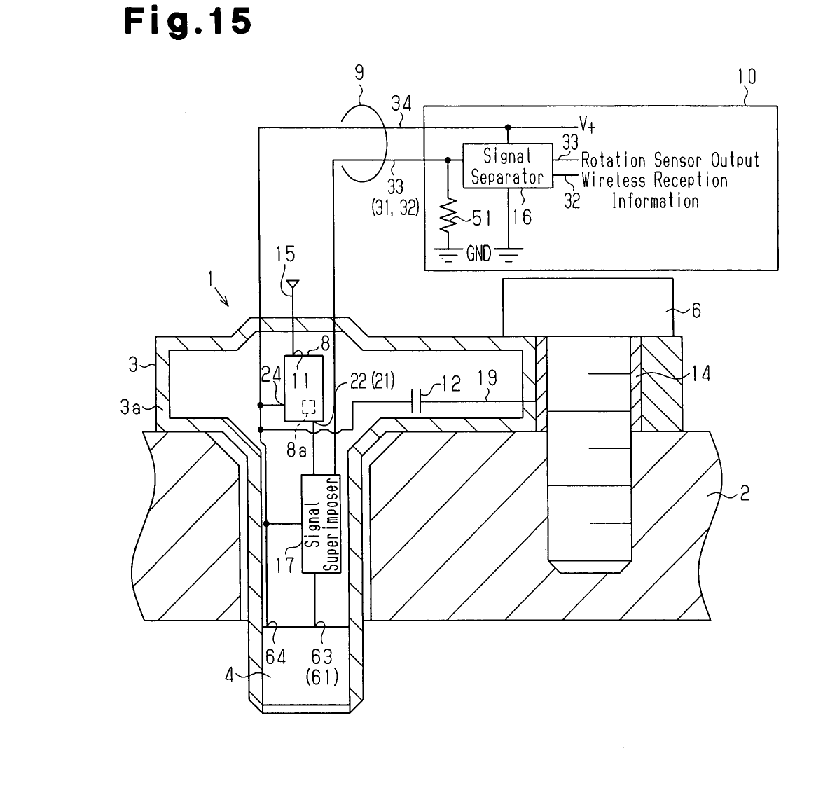

FIG. 15 shows a fourteenth embodiment in which the two-wire type wheel velocity sensor 4 and the receiver 8 shown in FIG. 14 are used. The wheel velocity sensor 4 outputs a pulse signal at a frequency proportional to the rotation velocity of the rotor 5 of the wheel. The receiver 8 digitizes information such as tire air pressure and outputs the information as a pulse train. Each output signal is input to the signal superimposer 17. The signal superimposer 17 changes the pulse shape (pulse voltage, pulse width etc.) of the pulse train of the output signal from the wheel velocity sensor 4 to prepare two or more types of pulse shapes, superimposes the signal from the receiver 8 on the signal from the wheel velocity sensor 4 with the pulse train as the carrier, and outputs the carrier to the controller 10. The signal separator 16 of the controller 10 separates the input from the signal superimposer 17 into a signal from the wheel velocity sensor 4 and a signal from the receiver 8.

As described above, the signal output wire 33 is shared by the wheel velocity sensor 4 and the receiver 8. Thus, only two wires connect the receiver unit 3 to the controller 10, the positive power supply wire 34 and the signal output wire 33. This reduces costs. The signal output wire 33 is also used as the negative power supply wire 31 and the signal output wire 32. Furthermore, the present invention is not limited to changing the output pulse shape of the wheel velocity sensor 4 and superimposing the output of the receiver 8 thereon, and the output of the receiver 8 may be inserted to the low level or the high level of the output of the wheel velocity sensor 4 using a pulse shape (shape of pulse voltage, pulse width etc.) that differs from the output pulse of the wheel velocity sensor 4.

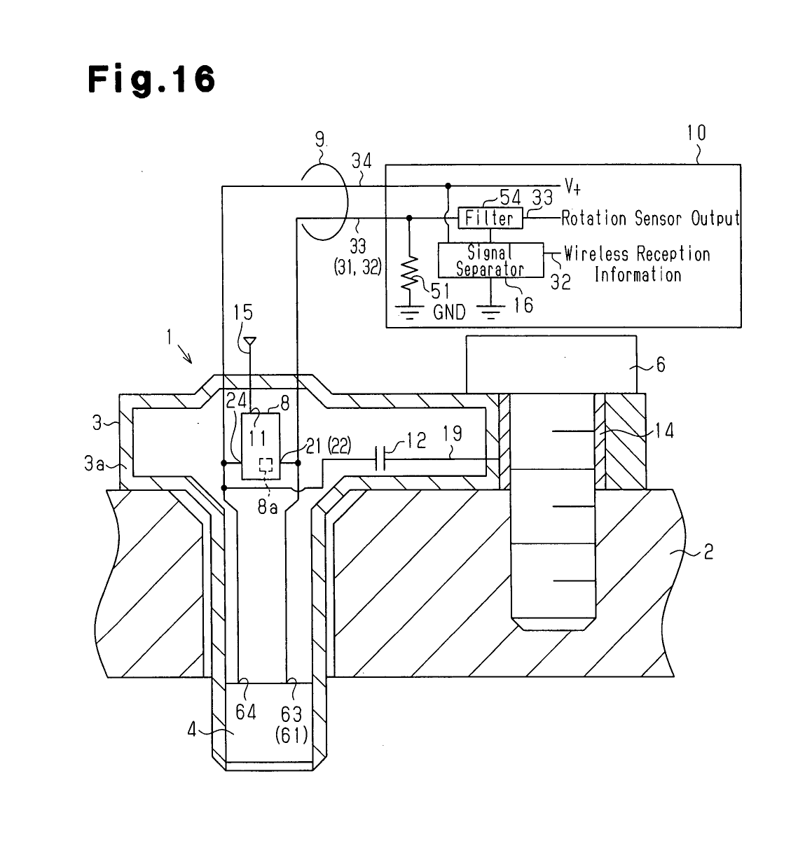

FIG. 16 shows a fifteenth embodiment, in which the wheel velocity sensor 4 outputs a pulse signal at a frequency proportional to the rotation velocity of the rotor 5. The receiver 8 demodulates the signal containing received information such as tire air pressure, lowers and outputs the carrier frequency of the signal received at the antenna 15 with a mixer and signal transmitting circuit in the receiver 8 in a range higher than the frequency band of the signal from the wheel velocity sensor 4, and then adds the same to the signal from the wheel velocity sensor 4 and transmits it to the controller 10.

In the controller 10, the signal from the wheel velocity sensor 4 is extracted by the low pass filter of the filter 54, and the signal from the receiver 8 is extracted by the high pass filter of the filter 54. Information corresponding to the tire air pressure is extracted by processing the output of the high pass filter in the signal separator 16 of the controller 10.

The reception signal of the receiver 8 has a frequency assigned to, for examples, vehicles. That is, the reception signal of the receiver 8 has a frequency of 315 MHz, 433 MHz, 866 MHz etc. Therefore, regarding the length of the wire 19, a length of one tenth or less than the wavelength of the reception signal of the receiver 8 is less than or equal to about 9.52 cm for 315 MHz, less than or equal to about 6.93 cm for 433 MHz, and less than or equal to about 6.46 cm for 866 MHz when calculating the velocity of light, for example, as three hundred thousand/sec.

The frequency used in the tire information detection device 1 may be other than that described above as long as it is in a frequency band acceptable for vehicles.

1. A tire information detection device for use on a vehicle having wheels with tires, the device comprising:
a housing fixed to a support member made of a conductive material and arrangeable on the vehicle;
a wheel velocity sensor, arranged in the housing, for detecting the rotation velocity of the wheel;
a receiver, arranged in the housing, for wirelessly receiving air pressure information of the tire; and
a controller for performing control in accordance with the detected rotation velocity and the air pressure information received by the receiver;
wherein the receiver includes a wireless frequency input terminal electrically connected to the support member.

2. The tire information detection device according to claim 1, wherein the wireless frequency input terminal is connected to the support member via a capacitor.

3. The tire information detection device according to claim 1, wherein the housing is fixed to the support member by a fastening member.

4. The tire information detection device according to claim 1, wherein:
the wireless frequency input terminal is a first wireless frequency input terminal;
the receiver further includes a second wireless frequency input terminal that differs from the first wireless frequency input terminal; and
the second wireless frequency input terminal is connected to an antenna.

5. The tire information detection device according to claim 1, wherein the receiver generates a new signal in accordance with a received signal.

6. The tire information detection device according to claim 1, wherein the receiver and the wheel velocity sensor are connected to a common positive power supply wire.

7. The tire information detection device according to claim 1, wherein a signal output wire extending from the receiver is also used as a negative power supply wire.

8. The tire information detection device according to claim 1, wherein a signal output wire extending from the wheel velocity sensor is also used as a negative power supply wire.

9. The tire information detection device according to claim 1, wherein the controller includes a signal separator for separating and outputting the signal input to the controller into a signal from the wheel velocity sensor and a signal from the receiver.

10. The tire information detection device according to claim 1, further comprising:
a signal superimposer for superimposing a signal from the wheel velocity sensor and a signal from the receiver, wherein the controller includes a signal separator for separating the signal superimposed in the signal superimposer into the signal from the wheel velocity sensor and the signal from the receiver.

11. The tire information detection device according to claim 1, wherein the receiver includes a signal processor for performing signal-processing in accordance with a received signal containing the air pressure information, the received signal being received by the receiver,
wherein the receiver includes one of a positive power supply terminal, a reference potential terminal, and a ground terminal connected to the support member via a wire having a length of one tenth or less the wavelength of the received signal.

12. The tire information detection device according to claim 11, further comprising an antenna for receiving the air pressure information, the antenna being connected to the receiver, and the antenna being arranged in the housing.

13. The tire information detection device according to claim 11, further comprising an antenna for receiving the air pressure information, the antenna being connected to the receiver, and the antenna being arranged along a wiring that connects the wheel velocity sensor to the controller.

14. The tire information detection device according to claim 11, further comprising a signal output wire extending from the wheel velocity sensor, the signal output wire also being used as a positive power supply wire or a negative power supply wire.

15. A tire information detection device for use on a vehicle having wheels with tires, the device comprising:
a housing fixed to a support member made of a conductive material and arrangeable on the vehicle;
a wheel velocity sensor, arranged in the housing, for detecting the rotation velocity of the wheel;
a receiver, arranged in the housing, for receiving a wireless signal containing at least the air pressure information of the tire; and
a controller for performing calculation on the tire information in accordance with a received signal,
wherein the receiver includes a signal processor for performing signal-processing in accordance with a received signal,
wherein the receiver includes one of a positive power supply terminal, a reference potential terminal, and a ground terminal connected to the support member via a wire having a length of one tenth or less the wavelength of the received signal.

16. The tire information detection device according to claim 15, further comprising an antenna for receiving the air pressure information, the antenna being connected to the receiver, and the antenna being arranged in the housing.

17. The tire information detection device according to claim 15, further comprising an antenna for receiving the air pressure information, the antenna being connected to the receiver, and the antenna being arranged along a wiring that connects the wheel velocity sensor to the controller.

18. The tire information detection device according to claim 15, further comprising a signal output wire extending from the wheel velocity sensor, the signal output wire also being used as a positive power supply wire or a negative power supply wire.
